(19) United States
(12) Patent Application Publication
(10) Pub. No.: US 2003/0120366 A1
(43) Pub. Date: Jun. 26, 2003

(54) Semiconductor cleaning system and method of controlling the operation of the same

(76) Inventors: Choul-Gue Park, Hwasung-Gun (KR); Deok-Yong Kim, Hwasung-Gun (KR)

Correspondence Address: VOLENTINE FRANCOS, P.L.L.C., Suite 150, 12200 Sunrise Valley Drive, Reston, VA, 20191, US

(21) Appl. No.: 10/309,166

(22) Filed: Dec. 4, 2002

(30) Foreign Application Priority Data
Dec. 20, 2001 (KR) 01-81959

(51) Int. Cl. G06F 17/00

(52) U.S. Cl. 700/90; 700/266

(57) ABSTRACT

A semiconductor cleaning system includes deionized water cleaning units for removing particles and chemicals from the wafer surface, and chemical cleaning units for removing organic materials and oxides from the wafer surface. The system is interlocked when chemicals used to clean the surface of a wafer are erroneously supplied to one or more chemical cleaning units of the system. To this end, the semiconductor cleaning system also includes a respective detection unit for detecting the state under which chemicals are being supplied to a chemical cleaning unit, a control unit for determining whether the cleaning system should be interlocked based on data from the detection units, and an alarm unit for providing an alarm in response to a control signal issued from the control unit.

### BACKGROUND OF THE INVENTION

1. Field of the Invention

The present invention relates to the manufacturing of semiconductor devices. More particularly, the present invention relates to a system for cleaning semiconductor wafers during the course of manufacturing semiconductor devices.

2. Description of the Related Art

Increases in the density, reduction in scale, and wiring patterns of semiconductor devices result in the creation of greater and greater step differences on a semiconductor wafer. Silicon on glass (SOG), the reflow of borophosphosilicate glass (BPSG), and chemical mechanical polishing (CMP) are techniques for planarizing a wafer to reduce such step differences. Among these techniques, CMP along with plasma enhanced chemical vapor deposition (PECVD) and reactive ion etching (RIE) are essential in producing sub-micron sized chips.

In CMP, a polishing solution is supplied onto a wafer to chemically react with the wafer surface. Simultaneously, the wafer is pressed by a polishing head against a polishing pad atop a polishing table, and the polishing head is rotated and orbited such that uneven regions of the wafer surface are flattened. A cleaning process is performed after the CMP process to remove various material which remains on the wafer surface as potential contaminants.

FIG. 1 schematically shows a cleaning system 10 for use with conventional CMP equipment. Referring to FIG. 1, a wafer, which has undergone a CMP process in CMP equipment, is introduced to the cleaning system 10 to remove contaminants from its surface. The cleaning system 10 includes: deionized water cleaning units 15a, 15b, and 15c, an NH₄OH cleaning unit 20 for removing organic materials from the wafer surface, and an HF cleaning unit 25 for removing oxides from the wafer surface. The cleaning system 10 further includes a drying unit 30 for drying the wafer surface after the surface has been cleaned with deionized water, NH₄OH, and HF. In the conventional cleaning system 10, the deionized water, NH₄OH, and HF cleaning units 15a, 15b, 15c, 20, and 25 receive deionized water, NH₄OH, and HF from a deionized water tank 45, an NH₄OH tank 55, and a HF tank 50, respectively. A manual valve 35 controls the flow of the deionized water, the NH₄OH, and the HF from the respective tanks thereof to the deionized water, NH₄OH, and HF cleaning units. The manual valve 35 is a two-way valve in which the flows of the chemicals such as the deionized water, the NH₄OH, and the HF are simultaneously controlled.

The operation of the above-described cleaning system proceeds as follows. First, the wafer, which has undergone the CMP process, is cleaned in the deionized water cleaning unit 15a, and the introduced into the NH₄OH cleaning unit 20 to remove organic materials therefrom. The wafer is then introduced into the deionized water cleaning unit 15b in which materials resulting from the NH₄OH cleaning process are in turn cleaned from the wafer. The wafer is then introduced into the HF cleaning unit 25. Oxides, which are produced on the wafer surface, are removed in the HF cleaning unit 25, and then the wafer is introduced into the deionized water cleaning unit 15c where materials resulting form the HF cleaning process are in turn cleaned from the wafer. The cleaned wafer is then dried in the drying unit 30 to thus complete the cleaning process.

However, the conventional cleaning system has the following problems.

Generally, operators perform a test to check whether the cleaning system is operating normally or prior to changing a recipe required for a special cleaning process. In either of these cases, the operator manually manipulates the manual valve 35 to test whether deionized water, NH₄OH, or HF is being normally supplied, or to change the recipe such as the amount of the deionized water, NH₄OH, or HF required for the special cleaning process.

However, after finishing the test, the operator may forget to readjust the manual valve 35. If the original cleaning process is performed in that state, only the deionized water or a specific chemical is continuously supplied. As a result, the wafer is damaged.

### SUMMARY OF THE INVENTION

An object of the present invention is to solve the above-described problems of the prior art by providing a semiconductor cleaning system which is interlocked when cleaning chemicals are erroneously supplied to one or more of the chemical cleaning units thereof.

Likewise, an object of the present invention is to provide a method of controlling the operation of a semiconductor cleaning system, wherein the cleaning system is interlocked when chemicals are erroneously supplied to one or more of the chemical cleaning units of the system.

It is still another object of the present invention to provide a semiconductor cleaning system that notifies an operator when a manual valve, that establishes the flow of cleaning chemicals in the system, is mis-positioned or the recipe of the cleaning process has been changed.

A semiconductor cleaning system according to the present invention comprises deionized water cleaning units for removing particles and chemicals from a surface of a wafer, at least one chemical cleaning unit for cleaning the wafer surface using chemicals, a detection unit associated with each chemical cleaning unit for detecting whether chemicals are being supplied properly to the chemical cleaning unit, i.e., in the manner required by the chemical cleaning process, a control unit for determining whether the cleaning system should be interlocked based on data from the detection unit, and an alarm unit triggered when the control unit determines that the chemicals are not being properly supplied to a chemical cleaning unit.

The detection unit includes a wafer sensor for detecting whether a wafer is present in the chemical cleaning unit, a flow meter having a sensor for detecting whether chemicals are flowing through a supply pipe connecting a source of the chemicals to the particular chemical cleaning unit, and a pressure sensor for detecting the pressure of the chemicals in the chemical supply pipe. The detection unit may further include a switching unit in which data from the flow meter and pressure sensors are selectively, i.e. alternately, supplied to the control unit. Preferably, the sensor of the flow meter is a photosensor that emits light when the chemicals are flowing through the pipe to which the meter is connected. The alarm unit may comprise an audio device for providing an audible alarm or a display element for providing a visual alarm.

The semiconductor cleaning system according to the present invention may include a first chemical cleaning unit for removing organic material from the wafer surface, and a second chemical cleaning unit for removing oxides from the wafer surface. Preferably, the chemical source that is connected to the first chemical cleaning unit is a source of NH₄OH, whereas the chemical source that is connected to the first chemical cleaning unit is a source of HF.

In this case, the detection unit associated with the second chemical cleaning unit also includes a potential of hydrogen (pH) measurement unit for measuring the pH of the HF.

A wafer, which has undergone a predetermined process, e.g. CMP, is first cleaned using deionized water in a deionized water cleaning unit of the system. Then, the wafer is introduced to a chemical cleaning unit. The presence of the wafer in the chemical cleaning unit triggers the detection for the flow of chemicals through the chemical supply pipe and the detection of the pressure of the chemicals in the chemical supply pipe. A protocol is provided to determine whether the cleaning system is to be interlocked or the wafer is to be cleaned by the chemical cleaning unit. Specifically, the protocol is provided by the program of a control unit. According to this protocol, the cleaning system is interlocked when the flow of the chemicals through the chemical supply pipe is not detected or when the pressure of the chemical supply pipe has increased beyond a given pressure. On the other hand, the chemical cleaning process is performed when the flow of the chemicals through the supply pipe is detected and the pressure of the chemical supply pipe has not increased beyond the given value.

According to the present invention, the state in which (liquid or gaseous) chemicals are being supplied to a chemical cleaning unit is detected. In the case in which the chemicals are being supplied incorrectly to the chemical cleaning unit for the desired cleaning process to occur, the cleaning system reports the abnormal operational state to an operator and interlocks the cleaning system. Therefore, the cleaning system is prevented from operating continuously in an abnormal state which, in turn, prevents the wafers from being damaged.

### BRIEF DESCRIPTION OF THE DRAWINGS

The above-described and other objects, features and advantages of the present invention will become more apparent from the following detailed description of the preferred embodiments thereof made with reference to the attached drawings, of which:

FIG. 1 is a block diagram of a conventional cleaning system for use with chemical mechanical polishing (CMP) equipment;

FIG. 2 is a block diagram of a semiconductor cleaning system according to the present invention;

FIG. 3 is a block diagram of an interlock section of the semiconductor cleaning system according to the present invention;

FIG. 4 is a flow chart illustrating the operation of the semiconductor cleaning system according to the present invention;

FIG. 5 is a block diagram of a second embodiment of a semiconductor cleaning system according to the present invention;

FIG. 6 is a block diagram of an interlock section of the second embodiment of the semiconductor cleaning system according to the present invention; and

FIGS. 7 and 8 are flow charts illustrating the operation of the second embodiment of the semiconductor cleaning system according to the present invention.

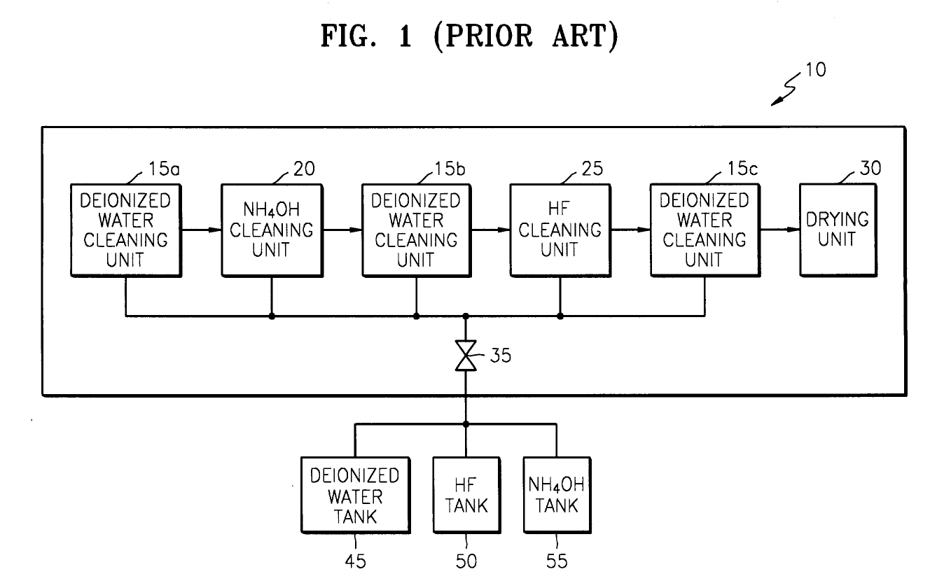

### DETAILED DESCRIPTION OF THE PREFERRED EMBODIMENTS

The present invention now will be described more fully with reference to the accompanying drawings, in which the preferred embodiments of the invention are shown.

[First Embodiment]

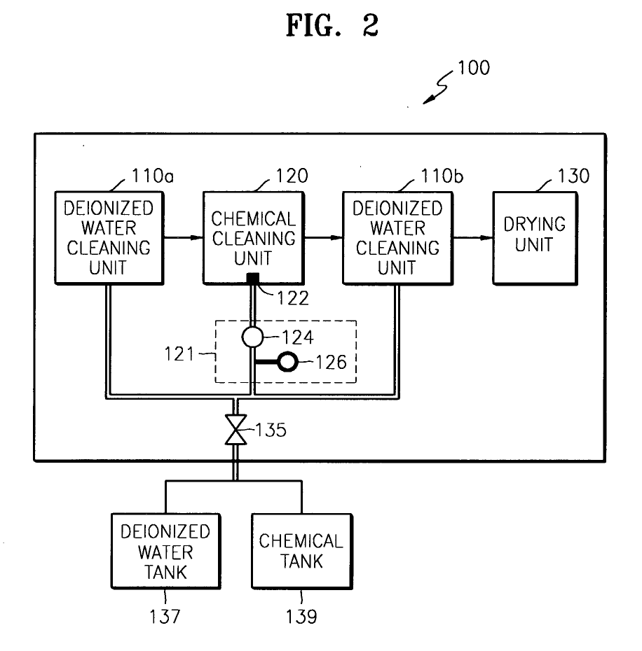

Referring to FIG. 2, a semiconductor cleaning system of the present invention includes deionized water cleaning units 110a and 110b for cleaning particles and chemicals from a wafer surface, a chemical cleaning unit 120 for removing contaminants from the wafer surface, and a drying unit 130 for drying the wafer surface. The deionized water cleaning units 110a and 110b and the chemical cleaning unit 120 receive deionized water and chemicals from a deionized water tank 137 and a chemical tank 139, respectively. A manual valve 135 controls the supply of the deionized water and the chemicals from the tanks. The manual valve 135 is, for example, a pneumatic valve. When air is supplied to the valve 135, the deionized water is supplied from the deionized water tank 137 while the flow of the chemicals to the chemical cleaning unit 120 is blocked. However, when air is not supplied to the valve 135, the flow of the deionized water to the deionized water cleaning units 110a, 110b is blocked while the chemicals are supplied to the chemical cleaning unit 120.

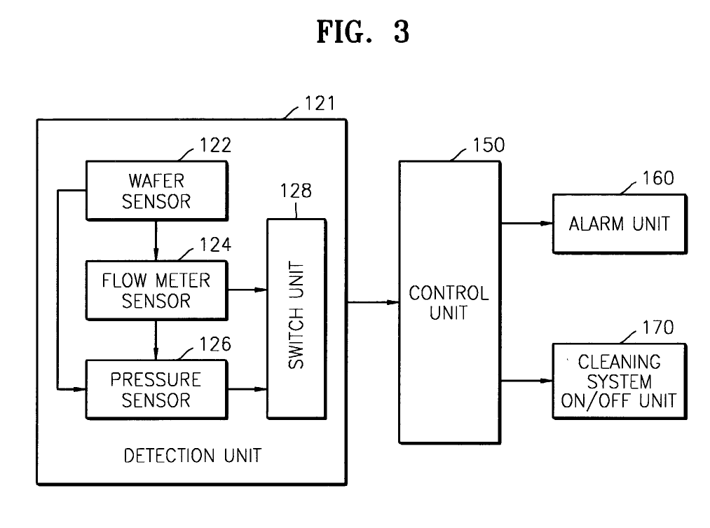

The cleaning system includes an interlock section for interlocking the cleaning system in response to an abnormal operation. The structure of the interlocking part will now be described with reference to FIGS. 2 and 3.

As shown in FIGS. 2 and 3, the interlock section includes a detection unit 121 for detecting the state in which chemicals are being supplied to the chemical cleaning unit 120, a control unit 150 for receiving a signal indicative of such state from the detection unit 121, and an alarm unit 160 that is operated by a signal from the control unit 150. The alarm unit 160 preferably comprises an audio device for providing an audible alarm or a display unit for providing a visual alarm.

The detection unit 121 includes a wafer sensor 122 for detecting the presence of a wafer in the chemical cleaning unit 120, a flow meter sensor 124 for detecting for the flow of chemicals into the chemical cleaning unit 120 once the wafer sensor 122 detects the wafer, and a pressure sensor 126 for detecting the pressure of the chemicals in a chemical supply pipe once the wafer sensor 122 detects the wafer. The detection unit 121 further includes a switching unit 128 for selectively outputting data from the flow meter sensor 124 and the pressure sensor 126 to the control unit 150. Preferably, the wafer sensor 122 is installed in the chemical cleaning unit 120, and the flow meter sensor 124 and the pressure sensor 126 are installed in the chemical supply pipe. Also, the flow meter sensor 124 preferably comprises a photosensor that emits light when the chemical is flowing at a certain rate through the supply pipe. The switching unit 128 may include a first switch for allowing data from the flow meter sensor 124 to be outputted, and a second switch for allowing data from the pressure sensor 126 to be outputted. The first and second switches are, for example, mechanical contact types of switches.

If a flow of chemicals is not detected by the flow meter sensor 124 even though a wafer has been introduced into the chemical cleaning unit 120 or there is an increase in fluid pressure in the supply pipe, the control unit 150 determines that the chemicals are not being supplied from the chemical tank 139 to the chemical cleaning unit 120. In this case, the control unit 150 outputs a control signal to a cleaning system on/off unit 170 to interlock the cleaning system.

The cleaning system is interlocked when an increase is detected in the fluid pressure in the supply pipe, for the following reasons. As described above, the manual valve 135 is a two-way valve that is selectively positioned based on whether air is being supplied thereto. When the air is being supplied to the manual valve 135, the manual valve 135 allows the deionized water to be supplied to the deionized water cleaning units 1110a, 11b while it blocks the flow of chemicals to the chemical cleaning unit 120. When the air is not being supplied to the manual valve 135, the manual valve 135 prevents the deionized water from being supplied to the deionized water cleaning units 110a, 110b while it allows the chemicals to be supplied to the chemical cleaning unit 120. Therefore, when the air is being supplied to the manual valve 135, the pressure of the fluid in the supply pipe increases.

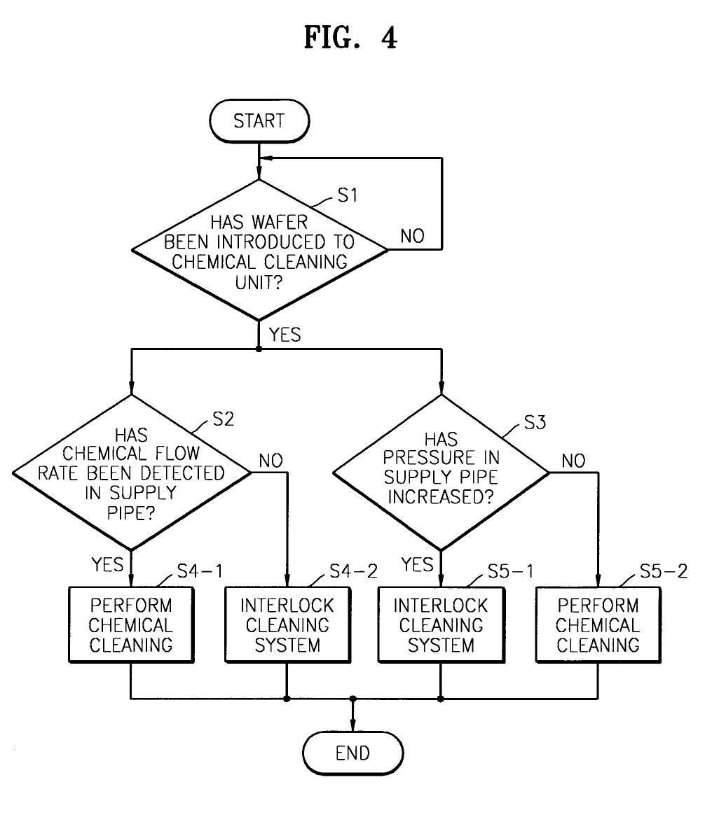

The operation of the semiconductor cleaning system will now be described with reference to FIGS. 2 through 4.

The wafer, which has been subjected to certain manufacturing processes, such as CMP, is carried to the semiconductor cleaning system 100. There, the wafer is dipped in the deionized water in cleaning unit 110a so as to be initially cleaned. The wafer, which has undergone the initial cleaning, is transferred to the chemical cleaning unit 120 containing the chemicals to remove organic materials or to remove oxides that have been produced on the wafer surface. When the wafer is dipped in the chemical bath of the chemical cleaning unit 120, the wafer sensor 122 detects the wafer (S1). When the wafer sensor 122 detects the introduction of the wafer into the chemical cleaning unit 120, the flow meter sensor 124 and the pressure sensor 126 detect for the flow of the chemicals through the supply pipe and an increase in the pressure of the fluid in the supply pipe, respectively (S2 and S3). If the wafer is not at first detected by the wafer sensor 122, the wafer sensor 122 remains in operation until the wafer is detected. If the flow meter sensor 124 detects the flow of the chemicals, the control unit 150 determines that the chemicals are supplied to the chemical cleaning unit 120 and are thereby performing a chemical cleaning process (S4-1). If the flow of the chemicals is not detected by the flow meter sensor 124, the control unit determines that the chemicals are not being supplied to the chemical cleaning unit 120, and then issues a signal that interlocks the cleaning system (S4-2). On the one hand, when the pressure sensor 126 detects an increase in the pressure of fluid in the supply pipe, the control unit 150 determines that the chemicals are not being supplied to the chemical cleaning unit 120, and then issues a signal to interlock the cleaning system (S5-1). Still further, as long as the pressure sensor 126 does not detect a certain build-up of pressure in the fluid in the supply pipe, the control unit 150 determines that the chemicals are being normally supplied to the chemical cleaning unit 120 and are thereby performing the chemical cleaning process (S5-2).

In the first embodiment, the chemical cleaning unit 120 has a built-in flow meter sensor 124 and pressure sensor 126 by which the cleaning system can be interlocked in the case in which the chemicals required for the chemical cleaning process are not being supplied to the chemical cleaning unit. Accordingly, the cleaning system is prevented from operating improperly, which improper operation could otherwise result in the wafers being damaged.

[Second Embodiment]

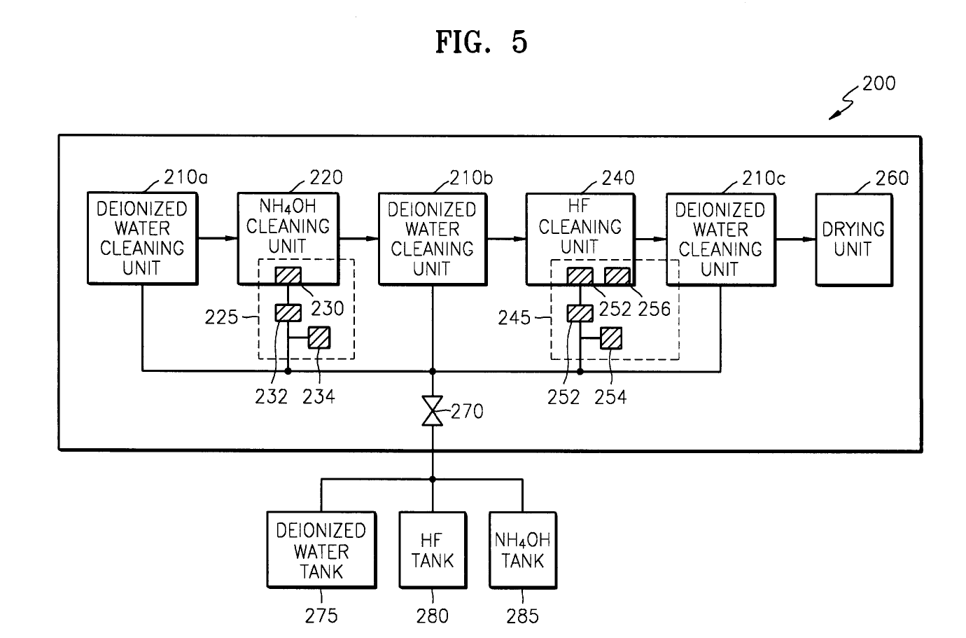

FIG. 5 shows another cleaning system 200 for removing contaminants from the surface of a wafer that has undergone CMP. The cleaning system 200 includes deionized water cleaning units 210a, 210b, and 210c for initially cleaning the wafer surface and for removing chemicals that have remained on the wafer surface, an NH₄OH cleaning unit 220 for removing organic materials from the wafer surface, and an HF cleaning unit 240 for removing oxides from the wafer surface. Furthermore, the cleaning system 200 includes a drying unit 260 for drying the wafer surface that has undergone the deionized water, NH₄OH, and HF cleaning processes.

The deionized water, NH₄OH, and HF cleaning units 210a, 210b, 210c, 220, and 240 receive deionized water, NH₄OH, and HF from a deionized water tank 275, an NH₄OH tank 285, and an HF tank 280, respectively. A manual valve 270 controls the flow of the deionized water, NH₄OH I, and HF. As in the first embodiment, the manual valve 270 is a two-way valve for simultaneously controlling the flows of the deionized water and chemicals such as the NH₄OH and HF. The manual valve 270 is also a pneumatic valve as in the first embodiment. Thus, when air is supplied to the manual valve 270, the deionized water is supplied from the deionized water tank 275 while the NH₄OH and HF are prevented from flowing to the NH₄OH and HF cleaning units. On the other hand, when air is not supplied to the manual valve 270, the valve prevents the deionized water from flowing to the deionized water cleaning units while allowing the NH₄OH or HF to be supplied to the respective cleaning unit.

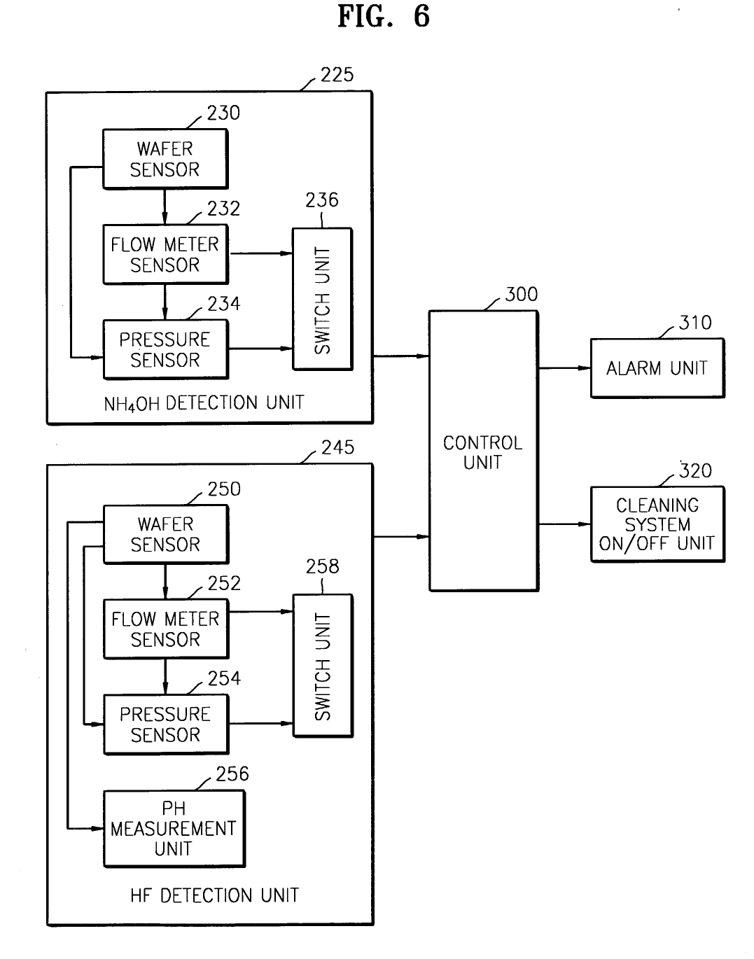

The cleaning system 200 also has an interlock section for interlocking the cleaning system in response to an abnormal operation. Referring to FIGS. 5 and 6, the interlock section of the cleaning system includes an NH₄OH detection unit 225 for detecting whether the NH₄OH I is being supplied to the NH₄OH cleaning unit 220, an HF detection unit 245 for detecting whether the HF chemical is being supplied to the HF cleaning unit 240, a control unit 300 for interlocking the cleaning system in response to data generated by the NH₄OH detection unit 225 or the HF detection unit 245, and an alarm unit 310 that can be triggered in response to a signal from the control unit 300. The alarm unit 310 is operated by a control signal from the control unit 300. Preferably, the alarm unit 310 comprises an audio device for issuing an audible alarm or a display unit for issuing a visible alarm. Also, the control signal generated by the control unit 300 for interlocking the cleaning system is output to a cleaning system on/off unit 320.

The NH₄OH detection unit 225 includes a wafer sensor 230 for detecting the presence of a wafer in the NH₄OH cleaning unit 220, a flow meter sensor 232 for detecting for the flow of the NH₄OH to the NH₄OH cleaning unit 220 once the wafer sensor 230 has detected the wafer, and a pressure sensor 234 for detecting the pressure of the NH₄OH in an NH₄OH chemical supply pipe once the wafer sensor 230 has detected the wafer. In addition, the NH₄OH detection unit 225 includes a switching unit 236 for selectively outputting data from the flow meter sensor 232 and the pressure sensor 234 to the control unit 300.

The wafer sensor 230 is preferably installed in the NH₄OH cleaning unit 220, and the flow meter sensor 232 and the pressure sensor 234 are preferably installed in the NH₄OH chemical supply pipe. Also, the flow meter sensor 232 is preferably a photosensor that emits light in response to the flow of the NH₄OH chemical through the NH₄OH chemical supply pipe. The switch unit 236 preferably includes a first switch for allowing data generated by the flow meter sensor 232 to be output to the control unit 300, and a second switch for allowing data generated by the pressure sensor 234 to be output to the control unit 300. Preferably, the first and second switches are mechanical contact types of switches.

The HF detection unit 245 includes a wafer sensor 250 for detecting the presence of the wafer in the HF cleaning unit 220, a flow meter sensor 252 for detecting whether the HF chemical is flowing to the HF cleaning unit 240 once the wafer sensor has detected the wafer, and a pressure sensor 254 for detecting the pressure of the HF in the HF chemical supply pipe once the wafer sensor 250 has detected the wafer. In addition, the HF detection unit 245 may include a potential of hydrogen (pH) measurement unit 256 comprising a pH sensor that measures the pH of the HF. The HF detection unit 245 further includes a switching unit 258 that allows data generated by the flow meter sensor 252 and the pressure sensor 254 to be selectively output to the control unit 300. In this case, as well, the wafer sensor 250 is preferably installed in the HF cleaning unit 240, and the flow meter sensor 252 and the pressure sensor 254 are preferably installed in the HF supply pipe. Also, the flow meter sensor 252 of the HF detection unit 245 is preferably a photosensor that emits light when the HF is flowing through the HF supply pipe. The switching unit 258 may include a first switch for allowing data generated by the flow meter sensor 252 to be output to the control unit 300, and a second switch for allowing data generated by the pressure sensor 254 to be output to the control nit 300. Preferably, the first and second switches are mechanical contact types of switches.

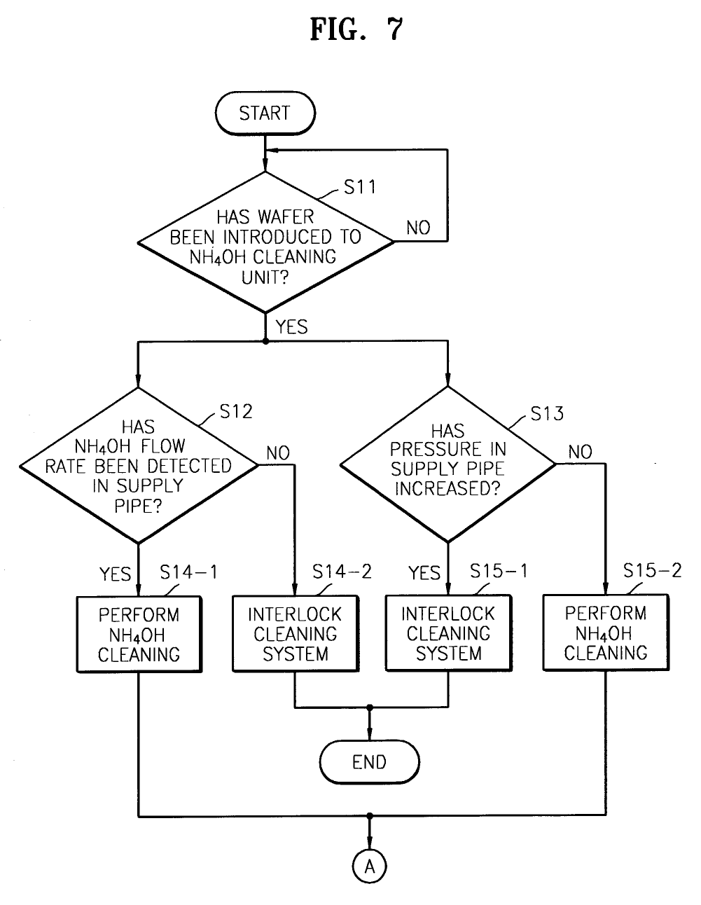

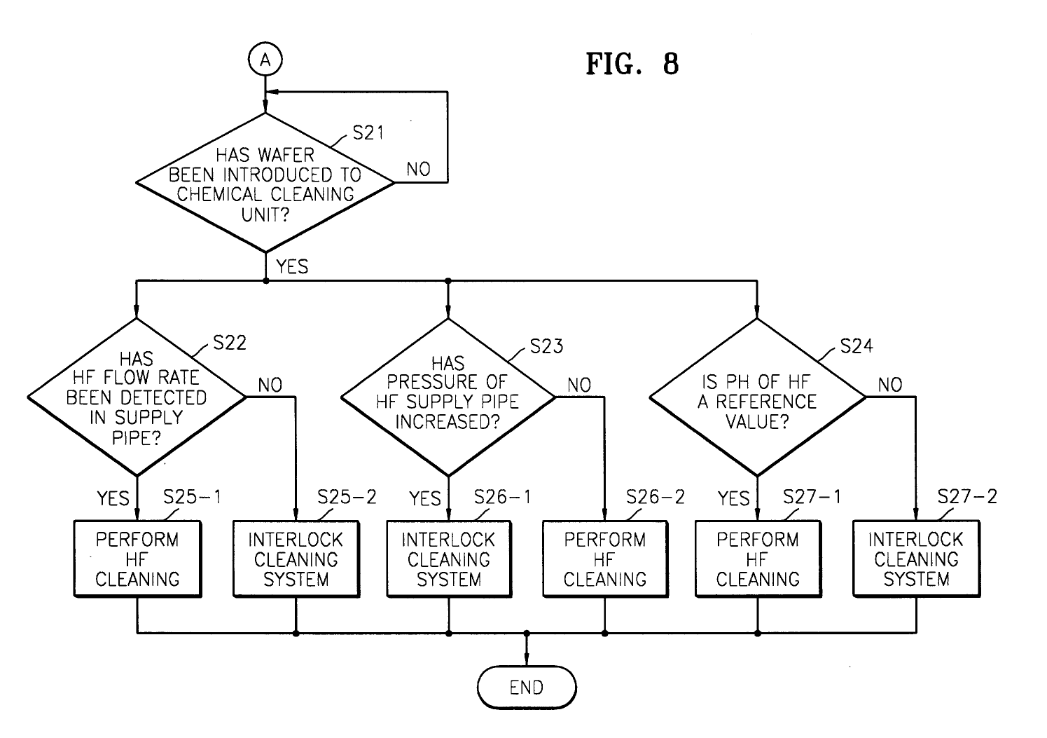

The operation of the semiconductor cleaning system 200 will now be described with reference to FIGS. 5 through 8.

The wafer, which has undergone a CMP process, is carried to the CMP cleaning system 200. The wafer is dipped in the deionized water of deionized water cleaning unit 210a so as to be initially cleaned. Then, the wafer is transferred to the NH₄OH cleaning unit 220 containing the NH₄OH to remove organic materials from the wafer surface. At this time, the wafer sensor 230 detects the introduction of the wafer into the NH₄OH cleaning unit 220 (S11). As long as the wafer has not been introduced to the NH₄OH cleaning unit 220, the wafer sensor 230 remains in operation, i.e., continues detecting for the presence of the wafer. Once the wafer sensor 230 has detected the wafer in the NH₄OH cleaning unit 220, the flow meter sensor 232 and the pressure sensor 234 detect for the flow of the NH₄OH through the supply pipe and for an increase in pressure of the of the NH₄OH in the supply pipe, respectively (S12 and S13). If the flow meter sensor 232 detects that the NH₄OH is flowing through the NH₄OH supply pipe, the control unit 300 determines that the NH₄OH is being normally supplied to the NH₄OH cleaning unit 220 and is thereby performing the NH₄OH cleaning process (S14-1). On the other hand, if the flow meter sensor 232 does not detect the flow of the NH₄OH chemical through the NH₄OH supply pipe, the control unit 300 determines that the NH₄OH is not being supplied to the NH₄OH cleaning unit 220 and accordingly, issues the control signal to the cleaning system on/off unit 320 to interlock the cleaning system (S14-2).

Still further, if the pressure sensor 234 detects a certain increase in pressure of the pressure of the NH₄OH in the supply pipe, the control unit 300 determines that the NH₄OH is not being supplied to the NH₄OH cleaning unit 220. Accordingly, the control unit 300 issues the control signal to the cleaning system on/off unit 320 to interlock the cleaning system (S15-1). On the other hand, if the pressure sensor 234 does not detect an increase in pressure in the supply pipe, the control unit 300 determines that the NH₄OH chemical is being normally supplied to the NH₄OH cleaning unit 220 and is thereby performing the NH₄OH cleaning process (S15-2).

A wafer, which has undergone the NH₄OH cleaning process, is dipped in the deionized water in the deionized water cleaning unit 210b to remove the NH₄OH from the wafer surface. The wafer is then introduced to the HF cleaning unit 240 to remove the oxides from the wafer surface. The wafer sensor 250 in the HF cleaning unit 240 detects whether the wafer has been introduced into the HF cleaning unit 240 (S21). As long as the wafer has not been introduced into the HF cleaning unit 240, the wafer sensor 250 remains in operation, i.e., continues to detect for the presence of the wafer. Once the wafer sensor 250 detects that the wafer has been introduced into the HF cleaning unit 240, the flow meter sensor 252 detects for the flow of the HF chemical through the supply pipe (S22). Meanwhile, the pressure sensor 254 detects for an increase in the pressure of the HF in the HF supply pipe (S23), and the pH measurement unit 256 senses the pH of the HF and compares the pH to a reference value (S24).

If the flow meter sensor 252 detects the flow of the HF chemical, the control unit 300 determines that the HF chemical is being normally supplied to the HF cleaning unit 240 and is thereby performing the HF cleaning process (S25-1). On the other hand, if the flow meter sensor 252 does not detect the flow of the HF, the control unit 300 determines that the HF is not being supplied to the HF cleaning unit 240, and issues the control signal to interlock the cleaning system (S25-2).

Still further, if the pressure sensor 254 detects an increase in the pressure of the HF in the HF supply pipe, the control unit 300 determines that the HF chemical is not being supplied to the HF cleaning unit 240, and thus issues the control signal to interlock the cleaning system (S26-1). On the other hand, if the pressure sensor 254 does not detect a certain increase in the pressure of HF in the supply pipe, the control unit 300 determines that the HF chemical is being normally supplied to the HF cleaning unit 240 and is thereby performing the HF cleaning process (S26-2).

In addition, the pH measurement unit 256 measures the pH of the HF so as to determine whether the pH of the HF chemical is equal to a reference value. If the pH of the HF chemical is equal to the reference value, the HF cleaning process is performed (S27-1). Otherwise, the cleaning system is interlocked (S27-2).

When the control unit 300 outputs a control signal for interlocking the cleaning system, the control unit 300 simultaneously outputs a control signal for operating the alarm unit 310.

According to the second embodiment of the present invention, if either one of the NH₄OH and HF is not being supplied to the respective NH₄OH and HF tanks in amounts required by the overall cleaning process, the cleaning system is interlocked and the operator is alerted to the erroneous state of operation of the cleaning system. Therefore, the operator can take appropriate measures to prevent the wafer from being damaged due to an abnormal operating state of the cleaning system.

Finally, although the present invention has been particularly shown and described with reference to the preferred embodiments thereof, various changes in form and details may be made thereto as will be apparent to those skilled in the art that. For example, the cleaning system and method may employ chemicals other than the disclosed NH₄OH and HF to remove the organic materials and the oxides after the CMP process. Also, a process gas(es) may be used instead of liquid chemicals. Therefore, all such changes are seen to be within the true spirit and scope of the invention as defined by the appended claims.

What is claimed is:

1. A semiconductor cleaning system, comprising:
a deionized water cleaning unit;
a source of deionized water for removing particles and chemicals from a wafer surface, said source of deionized water being connected to said deionized water cleaning unit so as to supply said deionized cleaning unit with deionized water;
a chemical cleaning unit disposed downstream of said deionized water cleaning unit in the system;
a source of chemicals capable of removing contaminants from a wafer surface, said source of chemicals being connected to said chemical cleaning unit so as to supply said chemical cleaning unit with said chemicals;
a detection unit including at least one detector operative to detect a state in which chemicals are being supplied from said source of chemicals to said chemical cleaning unit;
a control unit operatively connected to said detection unit so as to receive data therefrom indicative of whether chemicals are being supplied from said source of chemicals to said chemical cleaning unit in a manner suitable for a standard chemical cleaning process to occur in said chemical cleaning unit, said control unit issuing a control signal when the data indicates that the chemicals are not being supplied in said manner from said source of chemicals to said chemical cleaning unit; and
an alarm operatively connected to said control unit so as to be actuated when the control signal is issued by said control unit.

2. The semiconductor cleaning system of claim 1, and further comprising a chemical supply pipe connecting said source of chemicals to said chemical cleaning unit, and wherein said detection unit includes a wafer sensor operative to detect whether a wafer has been introduced into the chemical cleaning unit, and said at least one detector includes a flow meter comprising a sensor operatively connected to said chemical supply pipe so as to sense whether chemicals are flowing through the pipe to said chemical cleaning unit, and a pressure sensor operatively connected to said chemical supply pipe to sense the pressure of the chemicals in said pipe.

3. The semiconductor cleaning system of claim 2, wherein the detection unit further includes a switching unit interposed between said sensors and said control unit and operative to selectively transmit data from the sensor of the flow meter and the pressure sensor to the control unit.

4. The semiconductor cleaning system of claim 2, wherein said sensor of the flow meter is a photosensor that emits light when chemicals are flowing through said chemical supply pipe.

5. The semiconductor cleaning system of claim 1, wherein said alarm comprises one of an audio device or a visual display element.

6. The semiconductor cleaning system of claim 1, and further comprising a cleaning system on/off unit operatively connected to said control unit so as to be actuated by the control signal issued by said control unit, said on/off unit operative to shut the cleaning system down when the control signal is received from said control unit.

7. A semiconductor cleaning system, comprising:
at least one deionized water cleaning unit;
a source of deionized water for removing particles and chemicals from a wafer surface, said source of deionized water being connected to said at least one deionized water unit so as to supply said at least one deionized cleaning unit with deionized water;
a first chemical cleaning unit disposed downstream of a said deionized water cleaning unit in the system;
a first source of chemicals capable of removing organic materials from the wafer surface, said first source of chemicals being connected to said first chemical cleaning unit so as to supply said first chemical cleaning unit with said first chemicals;
a second chemical cleaning unit disposed downstream of a said deionized water cleaning unit in the system;
a second source of chemicals capable of removing oxides from the wafer surface, said second source of chemicals being connected to said second chemical cleaning unit so as to supply said second chemical cleaning unit with said second chemicals;
a first detection unit including at least one detector operative to detect a state in which chemicals are being supplied from said first source of chemicals to said first chemical cleaning unit;
a second detection unit including at least one detector operative to detect a state in which chemicals are being supplied from said second source of chemicals to said second chemical cleaning unit;
a control unit operatively connected to said first and second detection units so as to receive data therefrom indicative of whether chemicals are being supplied from said sources of chemicals to said chemical cleaning unit in a manner suitable for a standard chemical cleaning process to occur in said chemical cleaning units, said control unit issuing a control signal when the data indicates that the chemicals are not being supplied in said manner from said source of chemicals to said chemical cleaning units; and
an alarm operatively connected to said control unit so as to be actuated when the control signal is issued by said control unit.

8. The semiconductor cleaning system of claim 7, and further comprising a first chemical supply pipe connecting said first source of chemicals to said first chemical cleaning unit, and wherein said first detection unit includes a wafer sensor operative to detect whether a wafer has been introduced into the first chemical cleaning unit, and said at least one detector of the first detection unit includes a flow meter comprising a sensor operatively connected to said first chemical supply pipe so as to sense whether chemicals are flowing through the pipe to said first chemical cleaning unit, and a pressure sensor operatively connected to said first chemical supply pipe to sense the pressure of the chemicals in said first pipe.

9. The semiconductor cleaning system of claim 8, wherein the first source of chemicals is a tank of NH₄OH.

10. The semiconductor cleaning system of claim 7, and further comprising a second chemical supply pipe connecting said second source of chemicals to said second chemical cleaning unit, and wherein said second detection unit includes a wafer sensor operative to detect whether a wafer has been introduced into the second chemical cleaning unit, and said at least one detector of the second detection unit includes a flow meter comprising a sensor operatively connected to said second chemical supply pipe so as to sense whether chemicals are flowing through the pipe to said second chemical cleaning unit, and a pressure sensor operatively connected to said second chemical supply pipe to sense the pressure of the chemicals in said second pipe.

11. The semiconductor cleaning system of claim 10, wherein said second source of chemicals is a tank of HF.

12. The semiconductor cleaning system of claim 10, wherein said second detection unit further includes a pH sensor that measures the pH of the chemicals flowing to said second chemical cleaning unit.

13. The semiconductor cleaning system of claim 8, wherein each of the first and second detection units further includes a respective switching unit interposed between the sensors thereof and said control unit and operative to selectively transmit data from the sensor of the flow meter and the pressure sensor thereof to the control unit.

14. The semiconductor cleaning system of claim 10, wherein each of the first and second detection units further includes a respective switching unit interposed between the sensors thereof and said control unit and operative to selectively transmit data from the sensor of the flow meter and the pressure sensor thereof to the control unit.

15. The semiconductor cleaning system of claim 8, wherein said sensor of the flow meter of each of said detection units is a photosensor that emits light when chemicals are flowing through the chemical supply pipe to which said flow meter is connected.

16. The semiconductor cleaning system of claim 10, wherein said sensor of the flow meter of each of said detection units is a photosensor that emits light when chemicals are flowing through the chemical supply pipe to which said flow meter is connected.

17. The semiconductor cleaning system of claim 7, wherein said alarm comprises one of an audio device or a visual display element.

18. The semiconductor cleaning system of claim 7, and further comprising a cleaning system on/off unit operatively connected to said control unit so as to be actuated by the control signal issued by said control unit, said on/off unit operative to shut the cleaning system down when the control signal is received from said control unit.

19. A method of controlling the operation of a semiconductor cleaning system, the method comprising:
cleaning a wafer, which has been processed, using deionized water;
subsequently introducing the wafer into a chemical cleaning unit connected to a source of chemicals by a chemical supply pipe;
once the wafer is disposed in the chemical cleaning unit, detecting whether chemicals are flowing through the chemical supply pipe and detecting the pressure of the chemicals in the chemical supply pipe; and
providing a control protocol under which a control signal is issued when the chemicals are not detected to be flowing through the chemical supply pipe, and the control signal is issued when the pressure of the chemicals in the supply pipe increases beyond a first pressure;
interlocking the semiconductor device cleaning system when the control signal is issued; and
cleaning the wafer in the chemical cleaning unit when the chemicals are detected to be flowing through the chemical supply pipe and the pressure of the chemicals in the supply pipe remains below the first pressure.
